(19) United States
(12) Patent Application Publication
(10) Pub. No.: US 2013/0290197 A1
(43) Pub. Date: Oct. 31, 2013

(54) PATENT POWER CALCULATING DEVICE AND METHOD FOR OPERATING PATENT POWER CALCULATING DEVICE

(71) Applicant: Ichiro Kudo, Tokyo (JP)

(72) Inventors: Ichiro Kudo, Tokyo (JP); Youichi Yonezawa, Tokyo (JP); Kazuhiko Nakai, Tokyo (JP); Yasuko Kobayashi, Tokyo (JP); Takashi Matsuoka, Tokyo (JP)

(21) Appl. No.: 13/930,618

(22) Filed: Jun. 28, 2013

Related U.S. Application Data
(63) Continuation of application No. 12/666,044, filed on Dec. 22, 2009.

(30) Foreign Application Priority Data
Jun. 22, 2007 (JP) 2007-164465

(51) Int. Cl. G06Q 50/18; G06Q 10/10

(52) U.S. Cl. CPC G06Q 50/184; G06Q 10/10
USPC 705/310

(57) ABSTRACT

To propose a patent value evaluating device capable of identifying the causal association with business activity. A patent power calculating device comprises a patent history data acquiring section, an item content extracting section for searching for a combination of names of standard items indicating legal procedures and extracting the item contents and their procedure dates, a cost table holding section for holding a cost table where the combinations of item contents and prepared costs are associated with one another, an obsolescence function storage section for storing obsolescence functions used as indications of the obsolescence of the technology of the patent, a post-obsolescence cost calculating section for acquiring costs from the cost table and calculating the post-obsolescence cost by using the procedure date, and the obsolescence function, a totalizing section for totalizing the calculated post-obsolescence costs, and outputting the totalized value as the patent power.

This application is a continuation of U.S. patent application Ser. No. 12/666,044 filed Dec. 22, 2009, which is incorporated herein by reference in its entirety.

### FIELD OF THE INVENTION

The present invention relates to a calculation apparatus for patent power utilizing patent history data and an operation method thereof.

### BACKGROUND ART

Conventionally, patent evaluation methods are divided into a monetary evaluation method for calculating value of a patent, and a relative evaluation method used in think-tanks etc.

Examples of the conventional monetary evaluation methods include DCF method by scoring, Black-Scholes model, cost approach, or market approach. Since these methods are monetary and financial evaluations, they are useful in transferring patents etc, but the qualitative analysis (scoring) tends to be subjective, and when evaluating all patents, it costs enormously.

Meanwhile, examples of the relative evaluation methods include a statistical evaluation by analyzing the number of owned patents, registration rate, the number of applications and the number of claims etc, and technology evaluation by analyzing terms in application and technology chart etc. Since evaluations in these methods are carried out based on data, they are objective and effective in comparison of technological power with competitors, but it is difficult to determine a causal relationship between evaluation items and business activities (exclusive power of patents). For example, it is known that a company having a large number of patents does not always have earning power.

In addition, as the patent reference 1, when calculating patent value, market information of a product using the patent including market data, financial data, or marketing data, and rating scores regarding commercialization power, technological power, patent's strength, applicability to today's society and total power, are acquired. Subsequently, a profit creation index of the patent is calculated based on earning power of the product and profit contribution of the patent, thereby acquiring a theoretical price of the patent at the evaluation based on the profit creation index, formative effect of product market based on market scale of the product, risk rate and extensibility of the patent.

Patent Reference 1: Japanese Unexamined Patent Application Publication No. 2005-174313

### DISCLOSURE OF THE INVENTION

### Problems that the Invention Tries to Solve

However, when using the monetary evaluation methods as the patent reference 1, it is necessary to examine the market information and the scope of the respective patents, so that it is difficult to evaluate the patents at once. In addition, in the relative evaluation method, as described above, it is difficult to determine the causal relationship between evaluation items and business activities (exclusive power of patents). Therefore, there are difficulties in evaluation of a group of patents, and a suitable method has not been developed yet. In recent days, intellectual properties account for a large portion of corporate value, so that a standard indicator showing accomplishments of management of the intellectual properties is required. Therefore, the present invention provides the calculation apparatus for patent power according to the evaluation capable of determining the causal relationship between evaluation items and business activities (exclusive power of patents).

### Means for Solving the Problems

The present invention provides the following calculation apparatus for patent power and an operation method thereof.

Concretely speaking, in an aspect of the present invention, a calculation apparatus for patent power, comprising an acquisition unit for patent history data, acquiring patent history data of an application, an extraction unit for item content, searching for a combination of standard item names indicating legal procedures against the application by pattern matching processing utilizing a preliminarily given pattern, in which the standard item name is described in the acquired patent history data, and extracting the item content described in the patent history data correlated with procedure date in accordance with the retrieved combination of standard item names, a storage for search result, storing the extracted item content and the date correlated with the retrieved combination of standard item names, a storage for cost table, storing a cost table, in which a predetermined cost is correlated with a combination of item contents stored being correlated with the combination of standard item names, a storage for obsolescence function, storing obsolescence functions used as measures of the obsolescence of technique in each technical field, a calculation unit for post-obsolescence cost, acquiring cost with respect to each combination of item contents extracted according to the combination of standard item names of each application by means of the cost table stored in the storage for cost table, and calculating the post-obsolescence cost on a calculation reference date by means of the calculation reference date, the procedure date correlated with the combination of item contents, the filing date of the application, and the obsolescence function of the technical field of the application, a totalizing unit, totalizing the calculated post-obsolescence costs regarding the application, and an output unit, outputting the totalized value acquired by the totalizing unit, is provided.

In another aspect of the present invention, a method for operating a calculation apparatus for patent power, which comprises a storage for cost table, storing a cost table, in which a predetermined cost is correlated with a combination of item contents, correlated with the combination of standard item names and stored, and a storage for obsolescence function, storing obsolescence functions used as measures of the obsolescence of technique in each technical field, the method comprising the steps of acquiring patent history data of an application, extraction for item content, searching for a combination of standard item names indicating legal procedures against the application by pattern matching processing utilizing a preliminarily given pattern, in which the standard item name is described in the acquired patent history data, and for extracting the item content described in the patent history data correlated with procedure date in accordance with the retrieved combination of standard item names, storing the extracted item content and the date correlated with the retrieved combination of standard item names, calculation of post-obsolescence cost, acquiring cost with respect to each combination of item contents extracted according to the combination of standard item names of each application by means of the cost table stored in the storage for cost table, and calculating the post-obsolescence cost on a calculation reference date by means of the calculation reference date, the procedure date correlated with the combination of item contents, the filing date of the application, and the obsolescence function of the technical field of the application, totalizing the calculated post-obsolescence costs regarding the application, and outputting the totalized value acquired by the totalizing step, is provided.

### Effects of the Invention

According to the calculation apparatus for patent power of the first embodiment, it is possible to carry out the monetary evaluation of the group of patents. Moreover, the totalized value is calculated by the calculation apparatus for patent power utilizing only objective data without scoring, so that arbitrariness is completely excluded.

### DETAILED DESCRIPTION OF THE INVENTION

Embodiments of the present invention will be described hereinbelow with reference to the drawings. The present invention is not to be limited to the above embodiments and able to be embodied in various forms without departing from the scope thereof. The first embodiment will describe Claims 1 and 2.

### First embodiment

### Concept of First Embodiment

A brief description of the totalized value finally calculated by the calculation apparatus for patent power of the first embodiment is provided. The totalized value is calculated per an application. The calculation apparatus for patent power of the first embodiment carries out the calculation based on a brand new method for directly measuring the exclusive power of patent. Here, we consider that the worth of a patent is measured by the exclusive power of the patent. The exclusive power means a power indicating strength of a patent holder in monopolizing the market, in other words, a power of the patent as an obstacle to other competitors' business. It is possible to liken this exclusive power to a wall or a fence to make the boundary with competitors. When there is no competitor or no one who has an interest, it is meaningless to make the fence. For example, it is nonsense to make the fence on a deserted island to defend from a third party. Meanwhile, when there are competitors, it is highly significant to make the fence. If the fence is a great wall, which can perfectly exclude the third party, it is more highly significant. Accordingly, it is of great significance in making the wall for perfectly defending a large territory in the middle of Tokyo from the third party. This action to exclude the third party is the exclusiveness of the competitors, the large territory is a wide scope of patent right, and the great wall is a patent which is unlikely to be invalid.

In the business where there are many competitors, the strong patent covering the wide scope of right means the strong exclusive power. To have the strong exclusive power in the market benefits the patent holder. Therefore, the evaluation of the exclusive power of the patent is synonymous with the evaluation of earning power of the patent.

Subsequently, a description of an evaluation method for the exclusive power is provided. When the patent holder wishes to monopolize the market by the patent having the exclusive power, there are competitors to be excluded. Therefore, the competitor to be excluded takes the following actions against the patent having the exclusive power as an obstruction.

If the patent as the obstruction to the competitor's business is found, the competitor takes the following actions.

At the outset, the competitor researches the content of the patent, and should determine the action such as a negotiation of licensing, an action to invalidate, or a redesigning. Then, the competitor takes actions against the patent. Accordingly, it is preferable that the calculation apparatus for patent power of the first embodiment evaluates the actions by the third party against the patent as evaluation targets.

After the invention, there are various actions done to the patent from filing, publication, examination, registration to expiration. Examples of the action include an examination request, a rejection, a decision of a patent grant or a final decision for rejection, a request for inspection of files, an appeal trial, and a trial for invalidation. Among these actions, examples of the action by the third party include the request for inspection of files showing examination history of the patent and the trial for invalidation to invalidate the patent. The calculation apparatus for patent power of the first embodiment can evaluate such actions by the third party (competitor), thereby indexing the exclusive power of the patent.

Next, the reason why it is preferable to limit the evaluation target to the actions by the third party is described. For example, the action ‘filing’ by the applicant (right holder) is not the evaluation target. The reason for this is that a company having large number of patent applications does not always have earning power by the patent. For example, when most of the patent applications are treated as withdrawn without examination request or finally rejected in the examination, the large number of the patent applications is meaningless and such patent applications are not to be the evaluation targets. Moreover, if the action by the right holder is included in the evaluation target, it is possible for him to arbitrarily change the evaluation of himself.

Meanwhile, when the patent is non-negligible for the competitor and he cannot help investigating the patent, and as a result of the investigation, he determines that it is difficult to avoid the patent, so that he demands a trial for invalidation, it is expected that such patent is highly evaluated.

### Configuration of First Embodiment

FIG. 1 is a functional block diagram of a calculation apparatus for patent power of a first embodiment. A calculation apparatus for patent power (0100) in FIG. 1 comprises an ‘acquisition unit for patent history data’ (0101), an ‘extraction unit for item content’ (0102), a ‘storage for search result’ (0103), a ‘storage for cost table’ (0104), a ‘storage for obsolescence function’ (0105), a ‘calculation unit for post-obsolescence cost’ (0106), and a ‘totalizing unit’ (0107), and an ‘output unit’ (0108).

The ‘acquisition unit for patent history data’ (0101) has a function of acquiring patent history data of an application. An example of the patent history data includes standardized data in Japan acquired by standardizing and processing various information such as examination history information held by Japanese Patent Office. The patent history data includes legal procedures such as the trial for invalidation against a registered patent other than the examination history information. Moreover, not limited to the patent history, examination history information and post-registration information regarding utility model, design, or trademark are included. By referring the patent history data, information of filing date, applicant, inventor, and IPC etc, and existence or non-existence of the examination request, and the examination history can be known.

The ‘extraction unit for item content’ (0102) has a function of searching for a combination of standard item names indicating legal procedures against the application by pattern matching processing utilizing a preliminarily given pattern, in which the standard item name is described in the acquired patent history data, and extracting the item content described in the patent history data correlated with procedure date in accordance with the retrieved combination of standard item names.

Here, examples of the legal procedure against the application include a request for inspection of files and the trial for invalidation.

The combination of standard item names indicating legal procedures against the application is, for example, in the case of the trial for invalidation against the application, a combination of standard item names such as kind of trial case, kind of final decision, and conclusion of trial decision. By pattern matching processing of the patent history data utilizing this combination, the search for the trial for invalidation as the legal procedure is carried out. The data to search for the trial for invalidation as the legal procedure spreads across the patent history data, so that it is necessary to carry out the pattern matching processing, thereby extracting the item content etc. Subsequently, description of a method for extracting the item content described in the patent history data correlated with procedure date in accordance with the retrieved combination of standard item names is provided. FIG. 2 is a diagram exemplifying a part of patent history data (0200) (e.g., standardized data). The left side of FIG. 2 shows the standard item name (0201) and the right side shows the item content (0202). In FIG. 2, the item content corresponding to the standardized item name ‘kind of trial case’ is ‘112 (Full-invalid (New))’, the item content corresponding to the standardized item name ‘Kind of final trial decision’ is ‘02 (Dismissal of demand)’, and the item content corresponding to the standardized item name ‘conclusion of trial decision’ is ‘Y (Not invalid)’.

Moreover, the procedure dates correlated with these item contents are extracted. For example, in the case of the trial for invalidation, the ‘date of demand for trial’ is extracted. The ‘storage for search result’ (0104) has a function of storing the extracted item content and the date correlated with the retrieved combination of standard item names. For example, in FIG. 2, the item contents ‘112 (Full-invalid (New))’, ‘02 (Dismissal of demand)’, and ‘Y (Not invalid)’ are correlated with the combination of standard item names, and the procedure date 2004/04/01 is correlated with the combination of standard item names, and they are stored. By referring the stored search result, the date of demand for trial, the kind of trial case, the kind of final decision, and the conclusion of trial decision of the trial for invalidation as the legal procedure are acquired.

The ‘storage for cost table’ (0104) has a function of storing a cost table, in which a predetermined cost is correlated with a combination of item contents stored being correlated with the combination of standard item names. FIG. 3 is a diagram exemplifying a cost table. In the first line in FIG. 3, the combination of standardized item names is indicated. For example, the combination of standardized item names corresponding to the demand of trial for invalidation includes the kind of trial case, the kind of final decision, and the trial decision. In the second and third lines, examples of the combination of item contents are indicated. The example in the second line shows a case that the trial for invalidation was demanded, the demand was dismissed, and the decision was ‘Not invalid’. In this case, the cost for the trial for invalidation paid by the third party, for example, 1,000,000 (one million) yen is stored as the cost in the cost table. The example in the third line shows a case that the trial for invalidation was demanded, the demand was dismissed, and the decision was ‘Invalid’. In this case, the patent is invalid and has no value, so that zero is stored in the cost table. The cost may be stored in the cost table by unit of money, value acquired by division using appropriate value, or index corresponding to the legal procedure.

The ‘storage for obsolescence function’ (0105) has a function of storing obsolescence functions used as measures of the obsolescence of technique in each technical field. The obsolescence function is acquired as follows. The upper diagram in FIG. 4 is a graph of statistical results indicating how many years from filing the patents become invalid in a certain technical field. The vertical axis indicates the rate of expired patents, and the horizontal axis indicates the number of years from filing. In this statistical data, the point of filing is regarded as a starting point. This may sound quite natural because the obsolescence of technology starts not from the point of registration of patent, but from the point of invention. Therefore, although the point of invention seems to be the most appropriate starting point, it is impossible to work up statistics about it, so that the point of filing is set as the starting point. Concretely speaking, in the upper diagram in FIG. 4, the number of patents expired within 4 years from the filing is nearly zero. After that, the number of expired patents gradually increases. 25-30% of registered patents expire after 20 years from the filing date, The reason for this is that the term of the patent right is basically 20 years from the filing date. The patent rights, which would be maintained for longer term if the term of the patent right is longer than 20 years, expire at 20 years from the filing date. The technology is not obsolete at once. Therefore, based on the hypothesis that the patent rights, which expire at 20 years from the filing date, would gradually decrease during several years from the point of 20 years, it is expected that the patent rights decrease year-by-year at the rate indicated in the lower graph in FIG. 4. This is a graph indicating the obsolescence of technology as a source. FIG. 5 shows a result acquired by approximating the lower graph in FIG. 4 by normal distribution and calculating ‘1-normal cumulative distribution’. This curve is the obsolescence function. This may be called as a technological value obsolescence curve. Here, the reason for approximating the rate of expired patents by normal distribution is briefly provided. It is recognized that the respective registered patents has inventive step. Therefore, even if one patent becomes obsolete with technological advancement, no other patent becomes obsolete. Accordingly, each patent is independent, and can be approximated by normal distribution.

In FIG. 5, if the term of the patent right is not 20 years, most of patents lose their value around 25 years from the filing date. This graph has a feature that little obsolescence is found in the first several years, the rate of obsolescence accelerates as it approaches the average number of years that the patents expire, and after the average number of years of expiry, the rate of obsolescence becomes more gradual. This function is calculated with respect to each technical field, and is stored as the obsolescence function.

The ‘calculation unit for post-obsolescence cost’ (0106) has a function of acquiring cost with respect to each combination of item contents extracted according to the combination of standard item names of each application by means of the cost table stored in the storage for cost table, and calculating the post-obsolescence cost on a calculation reference date by means of the calculation reference date, the procedure date correlated with the combination of item contents, the filing date of the application, and the obsolescence function of the technical field of the application.

At the outset, description of a method for acquiring cost with respect to each combination of item contents extracted according to the combination of standard item names of each application by means of the cost table stored in the storage for cost table is provided. As shown in FIG. 3, the storage unit for cost table stores the cost with respect to each combination of item contents extracted according to the combination of standard item names indicating the legal procedures. Then, the cost table is searched by the extracted combination of standard item names, thereby acquiring the cost of matching combination.

Subsequently, a method for calculating the post-obsolescence cost by utilizing the obsolescence function is described with reference to FIG. 5. At the outset, the technical field of the application is acquired, and the obsolescence function corresponding thereto is acquired. After that, the calculation reference date and the procedure date correlated with the respective combination of the item contents, and the filing date of the application are acquired. In the case of a retroactive application, the original filing date may be acquired as the filing date. As described above, the reason for this is that the obsolescence of technology starts not from the point of registration of patent, but from the point of invention.

It is assumed that regarding to one patent, the trial for invalidation is demanded after a years from the filing and decision of maintenance of a patent is sentenced, and that a series of the procedures are 100 points in the cost table. Additionally, the calculation reference date is β years from the filing date. In this case, let a coefficient of residue value of technology for α years is T(α), and a coefficient of residue value of technology for β years is T(β), the post-obsolescence cost at the calculation reference date is:

The post-obsolescence cost=100×T(α)/T(β)

Assuming that the calculation reference date is now, if the date of the action (α years) is 2 years from the filing date, and now (β years) is 3 years from the filing date, the patent is not obsolete. if the date of the action (α years) is 2 years from the filing date, and now (β years) is 15 years from the filing date, the patent is seriously obsolete. Therefore, the older the legal action, the smaller its post-obsolescence cost at the present time.

The ‘totalizing unit’ (0107) has a function of totalizing the calculated post-obsolescence costs regarding the application. Therefore, it is possible to calculate the patent power for one application.

The ‘output unit’ (0108) has a function of outputting the totalized value acquired by the totalizing unit. It is possible to acquire a relation between the patent powers of companies by adding the totalized values with respect to each patent holder company. Thus, the totalized value outputted by the ‘output unit’ (0108) may be value acquired by adding the totalized values with respect to each specific unit.

### Hardware Configuration of First Embodiment

FIG. 6 is a hardware configuration diagram of the calculation apparatus for patent power of the first embodiment.

Note that the respective units in the first embodiment can be configured by hardware, software, or both hardware and software. For example, in the case of using a computer, the respective units are implemented by the hardware configured by a CPU, a memory, a bus, an interface, and other peripheral devices etc., and by the software operable on the hardware.

Concretely speaking, by sequentially carrying out programs on the memory, the data on the memory and the data inputted via the interface are processed, stored, and outputted etc., thereby implementing functions of the respective units.

Specifically, as shown in FIG. 6, a computer comprises a CPU (0601), a RAM (0602), a ROM (0603), an input/output interface (I/O) (0604), and a HDD (0605) etc. and they are connected with each other via data communication path such as a system bus (0606), thereby carrying out transmission/reception of information and processes.

Additionally, the RAM (0602) reads out a program for various processes to be executed by the CPU, and provides the work area for the program. A plurality of memory addresses are assigned to the RAM (0602) and the ROM (0603), respectively, and the program executed by the

CPU (0601) can be executed by specifying and accessing the address, and exchanging data.

With reference to FIG. 6, description of hardware configuration of the first embodiment is provided.

At the outset, when power of the calculation apparatus for patent power is on, the CPU (0601) develops the various programs such as a program for acquiring patent history data, a program for extracting item content, a program for storing search result, a program for calculating the post-obsolescence cost, a program for totalizing, a program for outputting, on the work area in the RAM (0602).

Subsequently, the CPU (0601) executes the program for acquiring patent history data, thereby acquiring the patent history data of the evaluation target patent. The acquired patent history data is stored in the data area in the RAM (0602). Subsequently, the CPU (0601) execute the program for extracting item content, and reads out the pattern file stored in the storage area in the ROM (0603) etc, on the data area in the RAM (0602). In the pattern file, the combination of standard item names of the legal procedures against the application is preliminarily stored. Then, the search for a combination of standard item names indicating legal procedures against the application by pattern matching processing utilizing the pattern file is carried out, thereby extracting the item content and procedure date, which are corresponding to the combination of standard item names. Subsequently, the CPU (0601) executes the program for storing search result, thereby correlating the extracted item contents and the procedure dates with the combination of standard item names, and storing them to the data area in the RAM (0602). Subsequently, the CPU (0601) executes the program for calculating the post-obsolescence cost. The CPU (0601) reads out the cost table and the obsolescence function to the data area in the RAM (0602). Then, by searching the cost table, the cost corresponding to the search result stored in the data area is acquired. Subsequently, the post-obsolescence cost is calculated by using the obsolescence function corresponding to the technical field of the application. The calculated post-obsolescence cost is stored in the data area in the RAM (0602). After that, the CPU (0601) executes the program for totalizing, thereby totalizing all post-obsolescence costs regarding the application stored in the data area in the RAM (0602). The totalized value is stored in the data area in the RAM (0602). Subsequently, the CPU (0601) executes the program for outputting, thereby outputting the totalized value thorough the input/output interface (I/0) (0604).

Moreover, the calculated totalized value may be correlated with the application number etc. and may be stored in the storage such as the HDD (0605).

### Processing Flow of First Embodiment

FIG. 7 is a flowchart showing processing in the calculation apparatus for patent power in a first embodiment.

At the outset, in a step S0701, the patent history data is acquired. Subsequently, in a step S0702, the combination of standard item names indicating legal procedures against the application by pattern matching processing is searched for by utilizing a preliminarily given pattern. Subsequently, in a step S0703, a process of extracting the item content described in the patent history data correlated with procedure date in accordance with the retrieved combination of standard item names is executed. Subsequently, in a step S0704, a process of storing the extracted item content and the date correlated with the combination of standard item names is executed. Subsequently, in a step S0705, the corresponding cost is acquired by searching the cost table. Subsequently, in a step S0706, the obsolescence function corresponding to the technical field of the application, the calculation reference date, the procedure date, and the filing date are acquired. Subsequently, in a step S0707, the post-obsolescence cost is calculated by using the acquired obsolescence function corresponding to the technical field of the application, the calculation reference date, the procedure date, and the filing date. Subsequently, in a step S0708, the calculated all post-obsolescence costs regarding application is totalized. Subsequently, in a step S0709, the acquired totalized value is outputted to the display etc.

Note that the flowchart of FIG. 7 may be regarded as a flowchart of processes to be executed by the computer. Moreover, such programs may be recorded in a media such as a CD or a IC memory.

### Brief Description of Effects of First Embodiment

According to the calculation apparatus for patent power of a first embodiment, it is possible to carry out economic evaluation of the group of patents.

Conventionally, it costs enormously to evaluate the economic value of one patent (e.g., 300,000 yen per a patent), so that it is difficult to carry out a micro-evaluation of the group of patents. The micro-evaluation is to carry out detailed survey for one patent, thereby calculating its economic value. In the calculation apparatus for patent power of a first embodiment, the evaluation target is the action taken by the third party after investigating a patent as an obstacle to his business and evaluating a degree of its obstuctiveness to his business, so that the result of the micro-evaluation by the third party is indirectly evaluated. Therefore, since the degree of obstuctiveness to the third party's business spreads across in the history information is utilized as the evaluation target, the evaluation is carried out utilizing the data with high quality even if it is a macro-evaluation.

Moreover, the totalized value per application calculated by the calculation apparatus for patent power is calculated by utilizing only objective data without scoring, so that arbitrariness is completely excluded.

### BRIEF DESCRIPTION OF THE DRAWINGS

FIG. 1 is a functional block diagram of a calculation apparatus for patent power of a first embodiment.

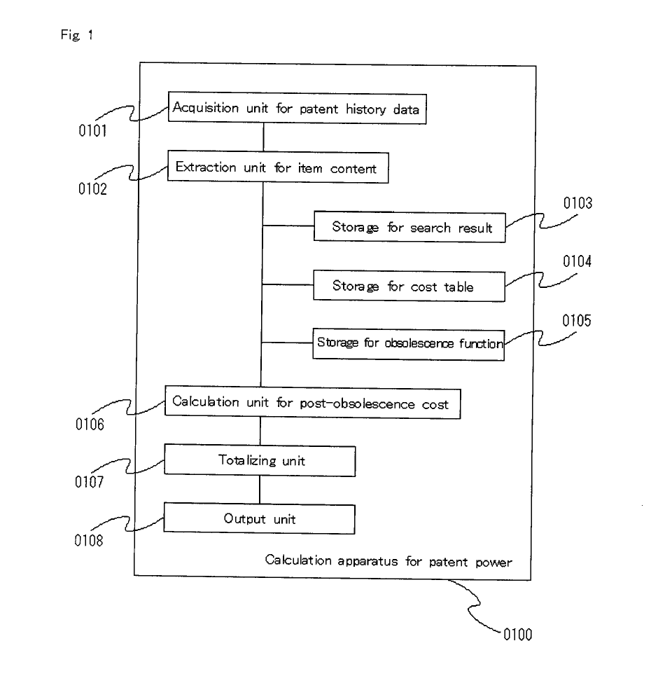

FIG. 2 is a diagram exemplifying a part of patent history data (e.g., standardized data).

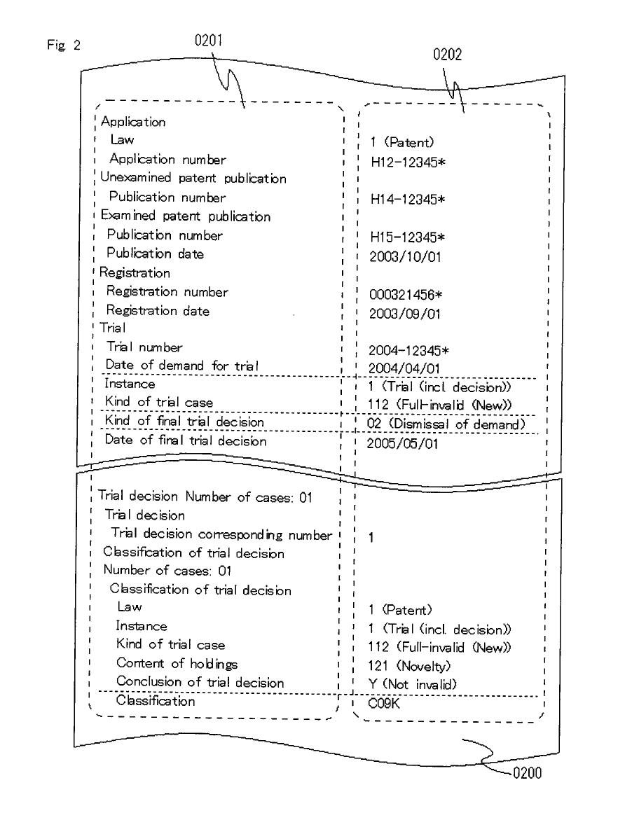

FIG. 3 is a diagram exemplifying a cost table.

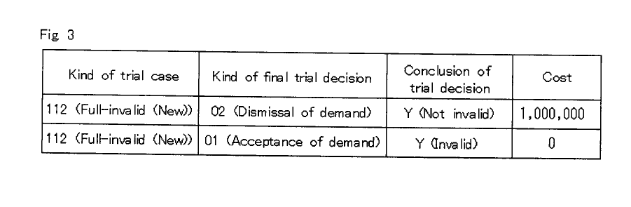

FIG. 4 is a diagram explaining calculation of obsolescence functions.

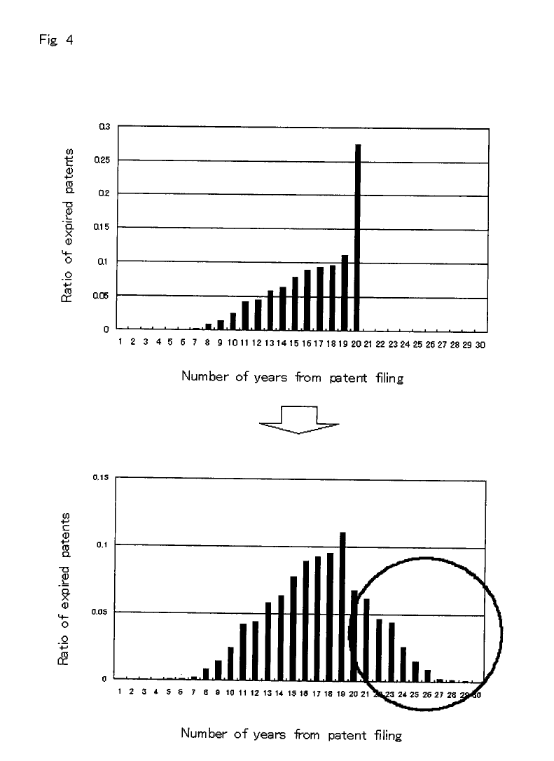

FIG. 5 is a diagram exemplifying the obsolescence functions.

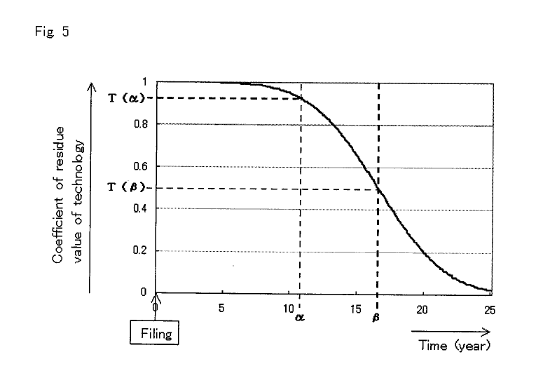

FIG. 6 is a hardware configuration diagram of the calculation apparatus for patent power of the first embodiment.

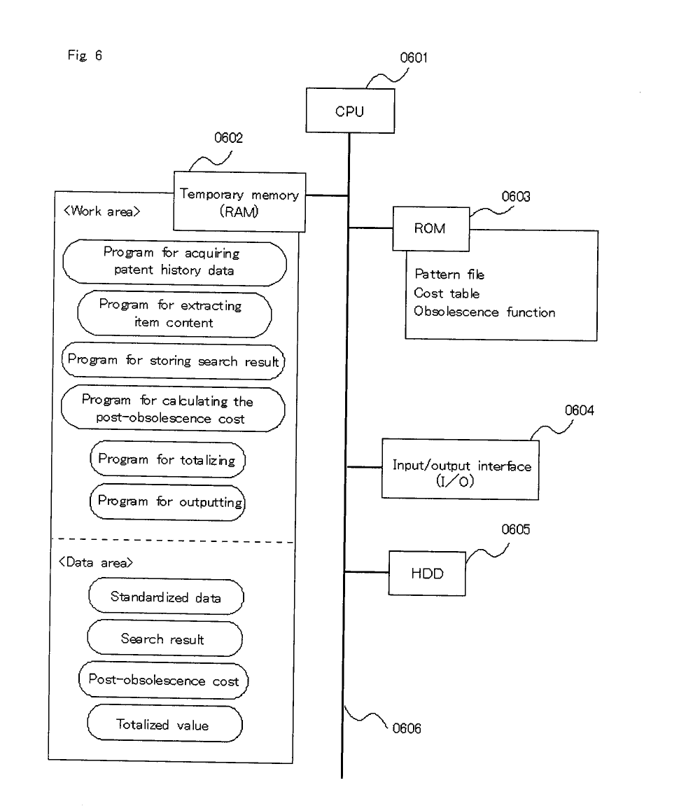

FIG. 7 is a flowchart showing processing in the calculation apparatus for patent power in a first embodiment.

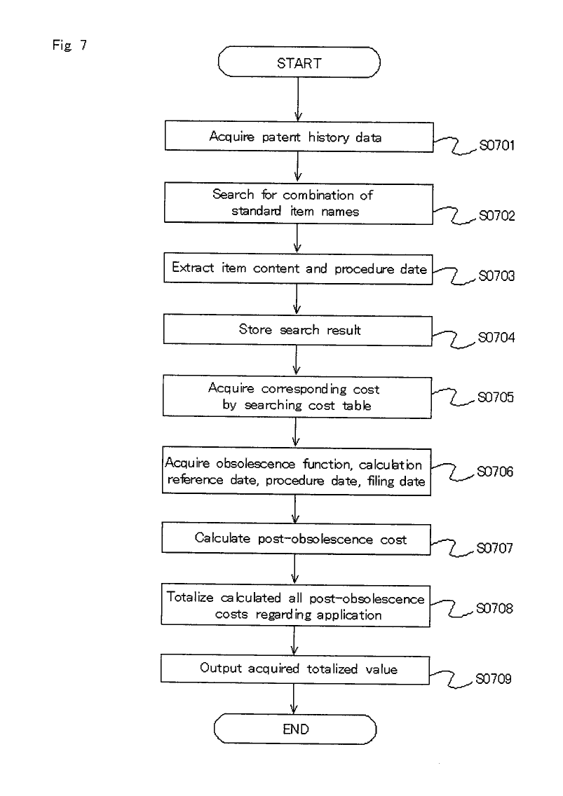

### DESCRIPTION OF REFERENCE NUMERALS

0100 Calculation apparatus for patent power
0101 Acquisition unit for patent history data
0102 Extraction unit for item content
0103 Storage for search result
0104 Storage for cost table
0105 Storage for obsolescence function
0106 Calculation unit for post-obsolescence cost
0107 Totalizing unit
0108 Output unit

What is claimed is:

1. A computer apparatus for calculating a patent power, comprising:
a patent history data acquisition unit, acquiring patent history data from a non-transitory computer readable medium;
an item content extraction unit, searching for a combination of standard item names listed in the acquired patent history data indicating legal proceedings undertaken for a patent (or a patent pending; the same shall apply hereinafter) through pattern matching processing utilizing a preliminarily given pattern, and extracting the item content listed in the patent history data correlated with a procedure date in accordance with the retrieved combination of standard item names;
a search result storage unit, storing the extracted item content and the procedure date correlated with the retrieved combination of standard item names;
a cost table storage unit, storing a cost table, in which predetermined costs correspond to a combination of item contents, such contents being correlated with the combination of standard item names;
an obsolescence function storage unit, storing obsolescence functions used as indications of the obsolescence of the technology of the patent in each technical field;
a post-obsolescence cost calculation unit, acquiring costs using the cost table stored in the cost table storage unit with respect to a combination of item contents extracted based on the combination of standard item names of each patent, and calculating the post-obsolescence costs on a calculation reference date by means of the calculation reference date, the procedure date correlated with the combination of item contents, the filing date of the patent application, and the obsolescence function of the technical field of the patent;
a totalizing unit, totalizing all the calculated post-obsolescence costs regarding the patent; and
an output unit, outputting the totalized value obtained via the totalizing unit as the patent power.

2. A method of operating a computer apparatus for calculating a patent power, comprising the steps of:
storing a cost table, in which predetermined costs correspond to a combination of item contents, such contents being correlated with the combination of standard item name, in a cost table storage unit;
storing obsolescence functions used as indications of the obsolescence of the technology of the patent in each technical field, in an obsolescence function storage unit;
acquiring patent history data from a non-transitory computer readable medium;
searching for a combination of standard item names listed in the acquired patent history data indicating legal proceedings undertaken for a patent (or a patent pending; the same shall apply hereinafter) through pattern matching processing utilizing a preliminarily given pattern, and extracting the item content listed in the patent history data correlated with a procedure date in accordance with the retrieved combination of standard item names;
storing the extracted item content and the procedure date correlated with the retrieved combination of standard item names, in a search result storage unit;
acquiring costs using the cost table stored in the cost table storage unit with respect to a combination of item contents extracted based on the combination of standard item names of each patent, and calculating the post-obsolescence costs on a calculation reference date by means of the calculation reference date, the procedure date correlated with the combination of item contents, the filing date of the patent application, and the obsolescence function of the technical field of the patent;
totalizing all the calculated post-obsolescence costs regarding the patent; and
outputting the totalized value obtained via the totalizing unit as the patent power.

3. The computer apparatus for calculating a patent power according to claim 1, wherein only costs related to legal proceedings for a patent implemented by a third party are totalized and the resultant is outputted as the patent power.

4. The computer apparatus for calculating a patent power according to claim 1, wherein only costs related to legal proceedings for a patent implemented by a patent right holder or a patent applicant are totalized and the resultant is outputted as the patent power.

5. The method of operating a computer apparatus for calculating a patent power according to claim 2, wherein only costs related to legal proceedings for a patent implemented by a third party are totalized and the resultant is outputted as the patent power.

6. The method of operating a computer apparatus for calculating a patent power according to claim 2, wherein only costs related to legal proceedings for a patent implemented by a patent right holder or a patent applicant are totalized and the resultant is outputted as the patent power.
